(19) United States
(12) Patent Application Publication
(10) Pub. No.: US 2009/0196361 A1
(43) Pub. Date: Aug. 6, 2009

(54) NON-BINARY SOURCE-TO-CHANNEL SYMBOL MAPPINGS WITH MINIMIZED DISTORTION

(75) Inventors: Ho Yin Chan, Hong Kong (CN); Wai Ho Mow, Hong Kong (CN)

Correspondence Address: TUROCY & WATSON, LLP, 127 Public Square, 57th Floor, Key Tower, CLEVELAND, OH, 44114, US

(73) Assignee: The Hong Kong University of Science and Technology, Hong Kong (CN)

(21) Appl. No.: 12/023,750

(22) Filed: Jan. 31, 2008

(51) Int. Cl. H04L 27/28

(52) U.S. Cl. 375/260

(57) ABSTRACT

System and methodologies for low-distortion index assignment for quantization are provided herein. Various aspects described herein utilize a graph theoretic approach for determining an index assignment mapping between a quantization codebook and a signal constellation by employing a variation of the subgraph isomorphism problem. The graph theoretic index assignment algorithms described herein allow efficient determination of index assignment mappings for both binary and non-binary quantization schemes. Further, the topological structure of a signal constellation can be exploited to simplify the set of subgraphs to be searched in select cases. Various aspects described herein can additionally be utilized to determine index assignment mappings for space-time block codes in a multiple-input multiple-output wireless communication system.

### TECHNICAL FIELD

The present disclosure relates generally to wireless communications systems, and more particularly to techniques for encoding data in a wireless communication system.

### BACKGROUND

Vector quantization has long attracted the interest of researchers as a powerful tool for lossy data compression. Because many traditional vector quantization techniques do not take into account the effect of transmission errors, there has been a growing trend toward the design of robust vector quantization algorithms that provide resilience to channel noise. One such approach is index assignment, which attempts to minimize overall distortion by determining an appropriate mapping from vector quantization indices to channel input symbols. Such an approach allows a vector quantization codebook and a channel modulation and coding set to be designed separately, as is the case in many existing communication systems.

Most conventional index assignment approaches are designed for binary symmetric channels. These conventional index assignment approaches operate by, for example, finding a binary indexing scheme for vector quantization vectors such that distortion resulting from transmission bit errors is minimized. However, many communication systems utilize non-binary modulation, such as M-phase shift keying (M-PSK) where M≠2. To apply conventional binary index assignment techniques to such a system, multiple mappings are generally required. For example, source data can first be mapped to binary vectors, which can then be in turn mapped to modulation symbols. To date, there have been no algorithms for guaranteeing the global optimality of such a series of mappings for non-binary modulation schemes. Accordingly, there exists a need in the art for more effective techniques for non-binary index assignment.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject disclosure provides systems and methodologies for non-binary index assignment for vector quantization. In particular, a graph theoretic approach is utilized, wherein non-binary index assignment is conducted by employing a variation of the subgraph isomorphism problem (e.g., given two graphs A and B, determining whether A is a subgraph of B). Further, by exploiting the topological structure of a signal constellation, the set of subgraphs to be searched can be simplified. In one example, a closed-form solution can be obtained for index assignment in some cases by imposing various constraints on a given signal constellation and a given quantizer. By utilizing a graph theoretic approach to index assignment as described herein, obtained index mappings can significantly outperform those obtained using traditional index assignment schemes. Various aspects described herein can additionally be applied to communication areas such as multiple-input multiple-output (MIMO) wireless communication systems, design of optimal bit-to-symbol mappings that minimize bit error probability, and the like.

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter can be employed. The claimed subject matter is intended to include all such aspects and their equivalents. Other advantages and novel features of the claimed subject matter can become apparent from the following detailed description when considered in conjunction with the drawings.

### BRIEF DESCRIPTION OF THE DRAWINGS

FIG. 1 is a high-level block diagram of a wireless communication system that can operate in accordance with various aspects described herein.

FIG. 2 is a diagram of an example communication channel in accordance with various aspects.

FIG. 3 is a block diagram of a system for performing non-binary index mapping in accordance with various aspects.

FIGS. 4-6 illustrate signal adjacency graphs for respective example communication channels in accordance with various aspects.

FIGS. 7-8 illustrate example index mapping techniques for respective example communication channels in accordance with various aspects.

FIG. 9 is a block diagram of a system for optimizing an index mapping in accordance with various aspects.

FIG. 10 illustrates an example technique for index mapping optimization in accordance with various aspects.

FIG. 11 is a block diagram of a system that facilitates index assignment mapping for a multiple-input multiple-output (MIMO) communication system.

FIG. 12 is a flowchart of a method of assigning indices for respective quantization levels used for wireless communication in accordance with various aspects.

FIG. 13 is a flowchart of a method of optimizing an index mapping for quantization in accordance with various aspects.

FIG. 14 is a block diagram of an example operating environment in which various aspects described herein can function.

FIG. 15 illustrates an example wireless communication network in which various aspects described herein can be utilized.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, the methods and apparatus of the claimed subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the claimed subject matter. The components may communicate via local and/or remote processes such as in accordance with a signal having one or more data packets (e.g., data from one component interacting with another component in a local system, distributed system, and/or across a network such as the Internet with other systems via the signal).

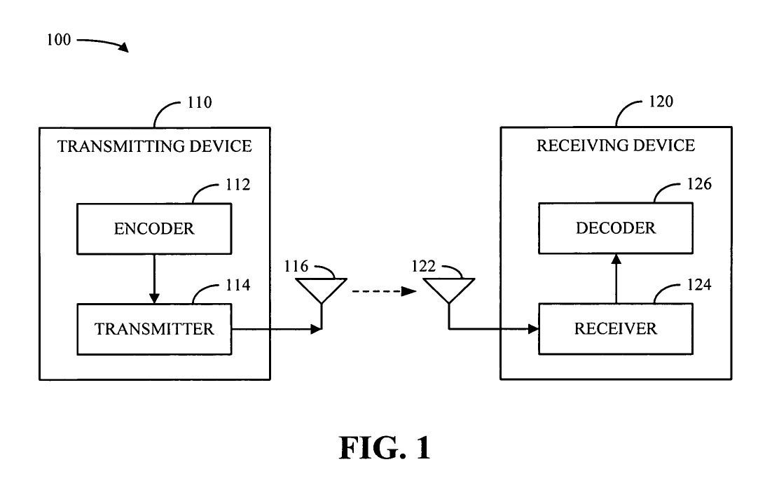

Referring to FIG. 1, a high-level block diagram of a wireless communication system 100 that can operate in accordance with various aspects described herein is illustrated. In one example, a transmitting device 110 in system 100 can transmit data and/or control signaling to a receiving device 120. While device 110 is labeled as a transmitting device and device 120 is labeled as a receiving device in system 100, it should be appreciated that a device 110 and/or 120 in system 100 can be capable of both receiving and transmitting at one or more time intervals. For example, while not illustrated in system 100, the receiving device 120 in system 100 can additionally transmit data and/or control signaling to the transmitting device 110 at a common time interval as a transmission from the transmitting device 110 to the receiving device 120 and/or at a different time interval.

In accordance with one aspect, transmitting device 110 can include an encoder 112 to process data and/or control signaling prior to transmission to receiving device 120. To this end, the encoder 112 can perform operations on data and/or control signaling such as vector quantization, modulation, coding, and the like. Data and/or signaling processed by the encoder 112 can then be transmitted to receiving device 120 and/or another device in system 100 by transmitter 114 via antenna 116.

At receiving device 120, data and/or signaling transmitted by transmitting device 110 and/or another device in system 100 can be received by receiver 124 via antenna 122. The received data and/or signaling can then be processed by a decoder 126 to convert the data and/or signaling into a form usable by the receiving device 120. Operations that can be performed by the decoder 126 include demodulation, inverse vector quantization, and the like. In one example, operations performed by the decoder 126 can be inversely related to corresponding actions performed by an encoder 112 at a transmitting device 110.

In accordance with another aspect, encoder 112 and transmitting device 110 and/or decoder 126 at receiving device 120 can utilize vector quantization for compression and/or other appropriate processing of data or signaling communicated between transmitting device 110 and receiving device 120. Vector quantization has long been recognized as a powerful tool for lossy compression of data such as speech, video, still pictures, and the like, although it should be appreciated that the vector quantization techniques described herein can be utilized for any appropriate data or signaling type and/or any appropriate operation(s) performed thereon.

Generally, the idea of vector quantization is to divide a signal space into regions wherein each region is represented by a “codevector.” When a signal is quantized, it can be represented by the codevector of the region the signal falls into. Upon quantization, the signal can then be identified by the index of its representative codevector. The index can then be used for operations such as storage and/or transmission of the signal. While the subject disclosure generally relates to vector quantization for transmission of signals, one of ordinary skill in the art can appreciate that similar techniques could be applied to storage of signals by viewing the read and write processes of storage systems as a communication channel.

In one example, encoder 112 at transmitting device 110 can begin vector quantization for a signal by assigning a codevector index to the signal. This index can then be transmitted through the communication channel via transmitter 114 and antenna 116. At the other end of the communication channel, the index can be received by antenna 122 and receiver 124 at receiving device 120. Decoder 126 at receiving device 120 can then reconstruct the input signal by performing a table look-up operation for the received index.

Many traditional vector quantization techniques perform partitioning of the signal space under an assumption of a noiseless communication channel. More particularly, the objective of such traditional techniques is to design a partition such that quantization noise is minimized. More recently, vector quantization techniques have been developed that attempt to consider the effect of a noisy communication channel on the distortion performance of vector quantization. In one such technique, a vector quantization codebook is constructed and updated using estimated channel statistics. Updates to the codebook can then be fed back to an associated transmitter. Further, the updates can be performed iteratively until a “channel-optimized” codebook is obtained.

In another such vector quantization technique, bit labels for respective codevectors are arranged such that respective codevectors, which are close in Euclidean space, have close bit labels in Hamming space. The motivation for this technique can be seen in the fact that a transmission error leads a transmitted bit vector to another bit vector. In such a situation, it is highly likely that a corrupted bit vector will be close to a transmitted vector if the noise power of the channel is relatively small. As a result, a subsequently reconstructed signal should likewise be close to the transmitted signal in Euclidean space.

To date, many conventional vector quantization techniques focus only on binary codevector index assignment due to the fact that bits have traditionally been viewed as a “common currency” in designing communication systems. However, due to bandwidth efficiency, many recent communication systems adopt high order M-ary modulation. Traditional vector quantization schemes can be utilized for high order modulation by utilizing two mappings—a first mapping that maps a source signal to one or more binary vectors and a second mapping that maps binary data to modulation symbols. In such a scheme, the first mapping should minimize distortion due to channel noise while the second mapping should minimize number of bit errors when a modulation symbol is wrongly detected. While best known solutions can be found for each such mapping, it can easily be shown by simulation that the joint performance of two best known mappings is sub-optimal. Thus, the two mappings are required to be jointly optimized for optimal performance.

Accordingly, to overcome the difficulties noted above, vector quantization techniques are described herein that consider non-binary index assignment, which can be viewed as a general case of binary index assignment. In one example, graph theory is utilized to formulate the index assignment problem as a subgraph isomorphism problem. Specific techniques that can be utilized for the accomplishment of this end are illustrated in more detail infra.

In accordance with one aspect, various techniques described herein can be utilized in connection with a decoder 126 that utilizes hard decoding and/or soft decoding detection schemes. In one example, a decoder 126 that utilizes hard decoding performs a hard decision on a signal received and simply determines a corresponding codevector. Alternatively, a decoder 126 that utilizes soft decoding can determine likelihood values for all signals in a signal set and provide an output such as, for example, an average of all codevectors weighted by their corresponding likelihood values rather than providing a single codevector output.

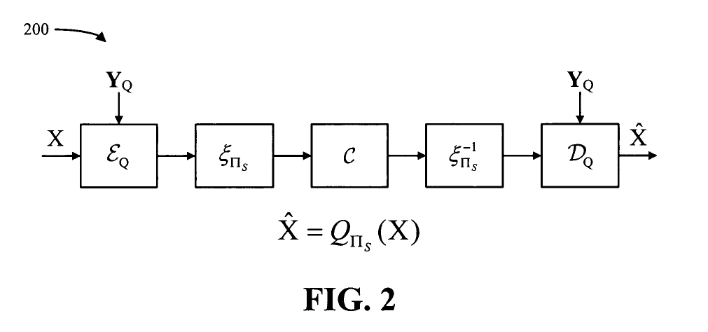

Referring now to FIG. 2, a diagram 200 of an example communication channel in accordance with various aspects is provided. In accordance with one aspect, a data source can be modeled as a k-dimensional vector random variable, X(Xε [symbol] ^{k}, having a probability density function p_{X}(\vec{x}). Thus, a realization of X can be written as \vec{x}=[x₀, x₁, . . . , xₖ₋₁]. As diagram 200 illustrates, the data source can then be compressed by a vector quantizer. In one example, a k-dimensional, M-point vector quantizer can include two main components: a codebook and a quantization function. In one example, a codebook Y_{Q} is a set of codevectors that represent the data source. The codebook can be defined as follows:

Y_{Q}={\vec{y}ᵢε [symbol] ^{k},iεI} (1)

where I={0, 1, . . . , M−1} is an index set. Additionally and/or alternatively, the quantization function Q can be a mapping of the following form:

Q: [symbol] ^{k}→Y_{Q}. (2)

If the communication channel is assumed to be noiseless, then the vector quantizer Q can be viewed as a composition of an encoder function and a decoder function, denoted by E_{Q} and D_{Q} respectively in diagram 200. In accordance with one aspect, the encoder function E_{Q}: [symbol] ^{k}→I can map an input sample \vec{x} to the index of a codevector that best represents \vec{x}. The decoder function D_{Q}:I→Y_{Q} can then map an index back to a corresponding codevector. In one example, the decoder function can map an index to a codevector by performing a table look-up operation. In one example, the definitions of the encoder and decoder functions can be combined to rewrite the quantization function Q for a noiseless channel as follows:

Q=D_{Q}∘E_{Q}. (3)

If, on the other hand, the communication channel is assumed to include channel noise, the effects of channel noise on a transmission of indices can result in significant quality degradation of corresponding reconstructed signals. Accordingly, an index assignment mapping ξ_{Π}_{_{S}} and an inverse assignment mapping ξ_{Π}_{_{S}}⁻¹ can additionally be incorporated into quantization function Q as illustrated by diagram 200 in accordance with various aspects.

From diagram 200, it can be appreciated that a main goal of vector quantization techniques for a noisy channel C is to protect quantized data from corruption by channel noise. It can be further appreciated that by indexing codevectors in a codebook, the average distortion caused by channel errors can be influenced. Thus, index assignment (IA) can act as a rate 1 channel code. The average distortion due to channel noise can then accordingly be reduced by re-arranging the codevectors such that index errors cause erroneously received vectors to be close to the original vectors.

Traditionally, vector quantization techniques have assumed a binary signal constellation, e.g., that n=log₂ M bits are used to represent one codevector from a codebook of size M. The signaling scheme used to transmit indices can be defined as S, where S={\vec{s}ᵢεAⁿ,nε [symbol] } and A is the space of the alphabets of the signaling scheme. For example, if phase shift keying (PSK) is utilized, then A= [symbol] with n=1. Alternatively, if pulse amplitude modulation (PAM) is utilized, then A= [symbol] with n=1. Further, in the case of binary transmission, S can be a set of all binary vectors of length n. In one example, a permutation function can be utilized to specify an index assignment. Such a permutation function can be defined as follows:

Π_{S}=[π₀,π₁, . . . ,π_{M-1}], (4)

where πₖε{0, 1, . . . , M−1} and indicates that the codevector \vec{y}_{π}_{ₖ} is assigned to the binary vector \vec{s}ₖ. Accordingly, the index assignment mapping can be defined as follows:

ξ_{Π}_{_{S}}(i)={\vec{s}ⱼ:πⱼ=i|Π_{S}}. (5)

As a result, the quantization function can be represented as follows:

Q_{Π}_{_{S}}=D_{Q}∘ξ_{Π}_{_{S}}⁻¹∘C∘ξ_{Π}_{_{S}}∘E_{Q}, (6)

and the index assignment problem can be formulated as follows:

$${Π}_{opt} = arg {min}_{{Π}_{s}} E {‖ X - {Q}_{{Π}_{s}} ( X ) ‖}^{2} . \qquad ( 7 )$$

In accordance with one aspect, solving the index assignment problem given by Equation (7) can be combinatorial in nature. Conventionally, only in special cases has the index assignment problem been studied analytically or have closed-form solutions been found. Instead, heuristic algorithms have been suggested to find a local optimal mapping. However, these conventional algorithms have left room for improvement, especially in the case of non-binary index assignment. For example, when non-binary symbols are considered as the common currency of a communication system, it can be appreciated that binary index assignment is not necessarily the best choice to minimize average distortion. Further, in the case of a communication system that employs adaptive modulation, many conventional vector quantization algorithms require different codebooks for different modulation levels, thereby increasing storage requirements. Accordingly, non-binary index assignment in accordance with various aspects described herein can be utilized to provide robust vector quantization in such an environment.

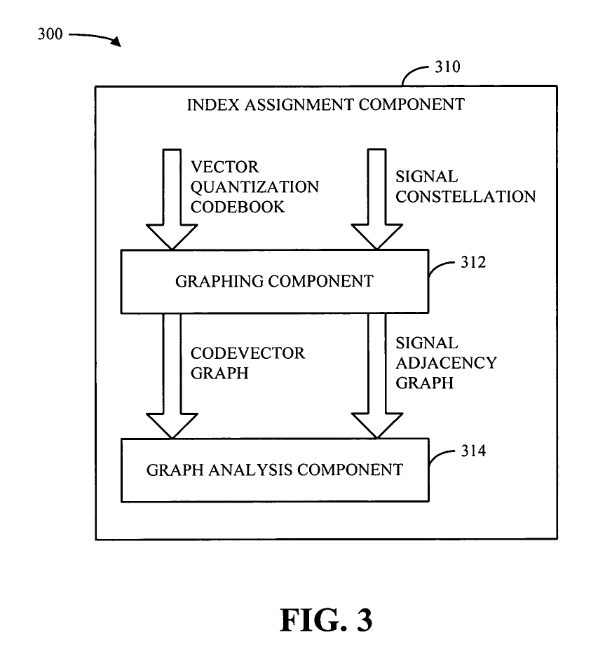

Turning to FIG. 3, a block diagram of a system 300 for performing non-binary index mapping in accordance with various aspects is provided. By way of specific example, system 300 can be utilized to facilitate vector quantization and can be employed by a device operating in a wireless communication system (e.g., transmitting device 110 and/or receiving device 120) and/or another suitable device. However, it should be appreciated that system 300 can also perform one or more techniques described herein to perform index assignment for a wireline communication system, a storage system, and/or any other system wherein data are desirably assigned respective indices. In accordance with one aspect, system 300 includes an index assignment component 310, which can facilitate vector quantization by formulating the non-binary index assignment problem as a graph-theoretic problem. In one example, the index assignment component 310 can include a graphing component 312, which can construct a codevector graph from a vector quantization codebook and a signal adjacency graph from a signal constellation (e.g., a signal constellation utilized by a modulator associated with index assignment component 310). Additionally and/or alternatively, the index assignment component 310 can include a graph analysis component 314 that can analyze a codevector graph and a signal adjacency graph to construct a source-to-channel symbol mapping for transmitted signals. The following description provides specific, non-limiting examples of techniques by which this mapping can be constructed.

As noted above, the objective of the index assignment problem for vector quantization in the presence of a noisy channel is to find an optimal assignment that minimizes the average reconstruction distortion. The problem can be formulated as follows:

$${Π}_{opt} = arg {min}_{{Π}_{s}} D ( {Q}_{{Π}_{s}} ) . \qquad ( 8 )$$

In accordance with one aspect, the average reconstruction distortion given in Equation (8) and generally used herein can be measured by mean p-th power distortion (MPD). In one example, MPD is a robust distortion measure that can be expressed as follows:

$$d ( \vec{x} , \vec{y} ) = {‖ \vec{x} - \vec{y} ‖}^{p} = {\sum }_{i = 0}^{k - 1} {\vert {x}_{i} - {y}_{i} \vert}^{p} , \qquad ( 9 )$$

where \vec{x}=[x₀, x₁, . . . , xₖ₋₁] and y=[y₀, y₁, . . . , yₖ₋₁] are two vectors in [symbol] ^{k}. From Equation (9), it can be appreciated that other distortion measures, such as mean squared distortion, mean-absolute distortion, and maximum distortion, can be obtained as special cases of MPD.

Without loss of generality, mean squared distortion experienced by system 300 can be considered as follows. From Equation (8), the following can be obtained through simple manipulations:

$$\begin{matrix}D ( {Q}_{{Π}_{s}} ) = E {‖ X - {Q}_{{Π}_{s}} ( X ) ‖}^{2} \\ = {\sum }_{i = 0}^{M - 1} {\sum }_{j = 0}^{M - 1} P ( {\vec{s}}_{j} \vert {\vec{s}}_{i} ) {\int }_{{R}_{i}}^{ } {‖ \vec{x} - {\vec{y}}_{{π}_{j}} ‖}^{2} d {p}_{x} ( \vec{x} ) \\ = {\sum }_{i = 0}^{M - 1} {\int }_{{R}_{i}}^{ } {‖ \vec{x} - {\vec{c}}_{i} ‖}^{2} {p}_{x} ( \vec{x} ) d x + \\ {\sum }_{i = 0}^{M - 1} {\sum }_{j = 0}^{M - 1} {P}_{{π}_{i}} P ( {\vec{s}}_{j} \vert {\vec{s}}_{i} ) {‖ {\vec{c}}_{{π}_{i}} - {\vec{y}}_{{π}_{j}} ‖}^{2} ,\end{matrix} \qquad ( 10 )$$

where Pᵢ is the probability that \vec{x} lies in the region Rᵢ (e.g., Pᵢ=∫_{R}_{ᵢ}pₓ(\vec{x})d\vec{x}), and \vec{c} is the centroid of this region (e.g., \vec{c}ᵢ=∫\vec{x}p(\vec{x})d\vec{x}). The first term in Equation (10) refers to the quantization error of an associated quantizer, which is independent of channel conditions and a utilized index assignment mapping. The second term in Equation (10) is the average distortion due to channel errors. Accordingly, finding an index assignment mapping ξ_{Π}_{ₛ} that minimizes the distortion D(Q_{Π}_{ₛ}) can be equivalent to finding a mapping that minimizes the second term of Equation (10), which can be referred to as distortion due to channel error or D_{C}(Q_{Π}_{ₛ}).

In accordance with one aspect, it can be assumed that a quantizer and source form a matched equiprobable pair. Thus, codevectors can be assumed to be the cell centroids of respective encoder regions, and the cells can be assumed to be equiprobable (e.g., Pᵢ=1/M and \vec{y}ᵢ=\vec{c}ᵢ for all i=0, 1, . . . , M−1). By denoting the “symbol squared distortion” between codevectors \vec{y}ᵢ and \vec{y}ⱼ as ε(i,j)=∥\vec{y}ᵢ−\vec{y}ⱼ∥², the distortion due to channel error can be expressed as follows:

$$\begin{matrix}{D}_{C} ( {Q}_{{Π}_{s}} ) = {\sum }_{i = 0}^{M - 1} {\sum }_{j = 0}^{M - 1} {P}_{{π}_{i}} P ( {\vec{s}}_{j} \vert {\vec{s}}_{i} ) {‖ {\vec{c}}_{{π}_{i}} - {\vec{y}}_{{π}_{j}} ‖}^{2} \\ = \frac{1}{M} {\sum }_{i = 0}^{M - 1} {\sum }_{j = 0}^{M - 1} P ( {\vec{s}}_{j} \vert {\vec{s}}_{i} ) ɛ ( {π}_{i} , {π}_{j} ) .\end{matrix} \qquad ( 11 )$$

A communication system such as the one illustrated by diagram 200 that utilizes hard decision detection or decoding can be viewed as a discrete memoryless channel (DMC). In one example, a discrete channel can be characterized by a set of conditional probabilities between the input and the output of the channel. For example, if the system is M-ary, then the set of probabilities can be expressed as {P(ŝ=\vec{s}ⱼ|s=\vec{s}ᵢ), ∀i,jεI}, where s is a transmitted symbol and s is a corresponding detected symbol. As used herein, P(ŝ=\vec{s}ⱼ|s=\vec{s}ᵢ) is denoted simply as P(ŝⱼ|\vec{s}ᵢ) for notational convenience. Further, a channel is said to be memoryless if the probability distribution of the output of the channel depends only on the input at the time of the input and is conditionally independent of previous channel inputs or outputs. In the following description, it is assumed that the communication channel C utilized is discrete and memoryless.

In accordance with one aspect, since it can be assumed that a quantizer and source form a matched equiprobable pair, then P(\vec{s}ᵢ)=1/M for all i. Accordingly, by Bayes' Theorem, P(\vec{s}ⱼ|\vec{s}ᵢ)=P(\vec{s}ᵢ|\vec{s}ⱼ). In one example, given that a signal \vec{s}ᵢ is sent, the probability of \vec{s}ⱼ being detected and the probability of \vec{s}ₖ(j≠k) being detected are different in many cases. Moreover, there often exists a set of signals such that the sum of their pairwise conditional error probabilities P(\vec{s}ₘ|\vec{s}ᵢ), for some mεI/{i}, dominate the overall conditional error probability P(error|\vec{s}ᵢ). This set can be denoted as E_{dom,i} and referred to as the set of dominating error events of \vec{s}ᵢ. Accordingly, the set of probabilities of a discrete memoryless channel can be expressed as:

$$P ( \hat{s} \neq {\vec{s}}_{i} \vert s = {\vec{s}}_{i} ) - {\sum }_{m ∈ {E}_{dom , i}} P ( \hat{s} = {\vec{s}}_{m} \vert s = {\vec{s}}_{i} ) < δ , \qquad ( 12 )$$

where δ is arbitrarily small. In other words, signals outside the set E_{dom,i} have very small pairwise conditional error probabilities and accordingly have negligible effect on the overall distortion represented by Equation (11). As a result, it can be appreciated that the terms corresponding to these negligible events can be ignored. Consequently, Equation (11) can be rewritten as follows:

$$\begin{matrix}{D}_{C} ( {Q}_{{Π}_{s}} ) = \frac{1}{M} {\sum }_{i = 0}^{M - 1} {\sum }_{j = 0}^{M - 1} P ( {\vec{s}}_{j} \vert {\vec{s}}_{i} ) ɛ ( {π}_{i} , {π}_{j} ) \\ = \frac{1}{M} {\sum }_{i = 0}^{M - 1} [ {\sum }_{{\vec{s}}_{j} ∈ {E}_{dom , i}} P ( {\vec{s}}_{j} \vert {\vec{s}}_{i} ) ɛ ( {π}_{i} , {π}_{j} ) + \\ {\sum }_{{\vec{s}}_{j} ∉ {E}_{dom , i}} P ( {\vec{s}}_{j} \vert {\vec{s}}_{i} ) ɛ ( {π}_{i} , {π}_{j} ) ] \\ \approx \frac{1}{M} {\sum }_{i = 0}^{M - 1} {\sum }_{{\vec{s}}_{j} ∉ {E}_{dom , i}} P ( {\vec{s}}_{j} \vert {\vec{s}}_{i} ) ɛ ( {π}_{i} , {π}_{j} ) .\end{matrix} \qquad ( 13 )$$

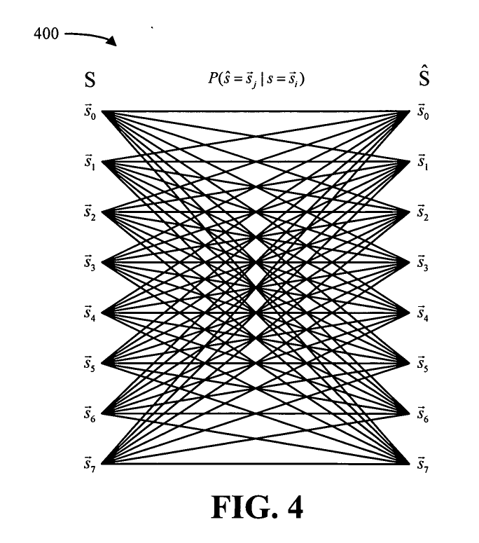

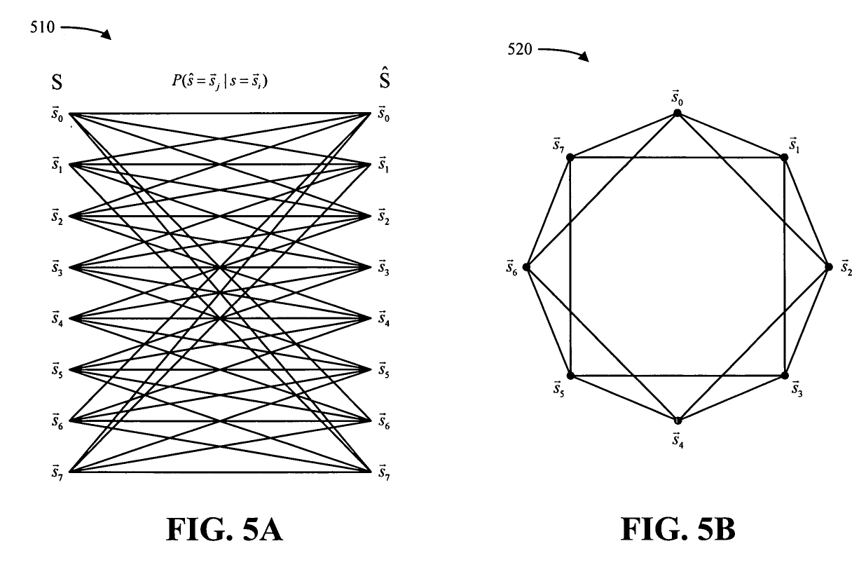

Trellis 400 in FIG. 4 characterizes a DMC for an 8-symbol constellation by illustrating the error relationships between transmitted signals S and received signals Ŝ. As trellis 400 illustrates, each symbol transmitted over the DMC characterized by trellis 400 can be received as any symbol in the constellation. However, by ignoring events that are not within the respective sets of dominating error events for each signal, trellis 400 can be reduced as illustrated by trellis 510 in FIG. 5A. It should be appreciated that in many situations, the distribution of dominating error events and the topology of a signal constellation are closely related. However, for purposes of generality in the following description, the topology of a given signal constellation is not considered.

By reducing the error probabilities of a DMC as illustrated by Equation (13) and trellis 510 in FIG. 5A, the index assignment problem considered by index assignment component 310 can be viewed from another perspective. First, a graph G_{Q} can be defined as a quantizer graph, which can further be defined as a graph induced by a codebook Y_{Q} of a vector quantizer. The graph G_{Q}={V_{Q},E_{Q}} can additionally be assumed to be a complete graph. Graph G_{Q} can have a node set V_{Q}={0, 1, . . . , M−1}, in which each node corresponds to one codevector in Y_{Q}. Thus, since G_{Q} is a complete graph, for any pair of nodes i,jεV_{Q}, it can be appreciated that {i,j}εE_{Q} (or, in other words, E_{Q}={{i,j}, ∀i,jεV_{Q}}). Each edge {i,j} can refer to an event wherein \vec{y}ᵢ (or \vec{y}ⱼ) is transmitted while \vec{y}ⱼ (or \vec{y}ᵢ, respectively) is reconstructed due to channel error. Further, an edge weight for a given edge can be defined as the distortion between the two codevectors corresponding to the two nodes connected by the edge.

Additionally, a similar graph G_{S}={V_{S},E_{S}}, referred to herein as a signal adjacency graph, can be defined for a transmission scheme over the DMC. In one example, V_{S}={0, 1, . . . , M−1} is the node set of G_{S}, in which each node corresponds to one signal in a corresponding signal constellation S. Further, for each node i, edges can be established between the node i and its set of dominating error events. Thus, E_{S}={{i,j}, ∀i, where jεE_{dom,i}}. In another example, the edge weight of a given edge {i,j} is equal to the pairwise conditional error probability P(\vec{s}ᵢ|\vec{s}ⱼ) (or P(\vec{s}ⱼ|\vec{s}ᵢ)). Graph 520 in FIG. 5B illustrates a signal adjacency graph G_{S} of the transmission scheme over the DMC specified by trellis 510 in FIG. 5A. It should be appreciated that graph 520 can be constructed, for example, by graphing component 312, by manipulating trellis 510 to obtain a signal adjacency graph that is graphically equivalent to trellis 510.

Utilizing the graphical notion of quantizers and a transmission scheme over a DMC, Equation (13) can be expressed as follows:

$$\begin{matrix}{D}_{C} ( {Q}_{{Π}_{s}} ) \approx \frac{1}{M} {\sum }_{i = 0}^{M - 1} {\sum }_{{\vec{s}}_{j} ∈ {E}_{dom , i}} P ( {\vec{s}}_{j} \vert {\vec{s}}_{i} ) ɛ ( {π}_{i} , {π}_{j} ) \\ = \frac{2}{M} {\sum }_{\{ i , j \} ∈ {E}_{s}} P ( {\vec{s}}_{j} \vert {\vec{s}}_{i} ) ɛ ( {π}_{i} , {π}_{j} ) .\end{matrix} \qquad ( 14 )$$

It can be observed that the summation in Equation (14) counts every edge in G_{S} once. Thus, the problem of finding an index assignment mapping ξ_{Π}_{ₛ} that minimizes D_{C}(Q_{Π}_{ₛ}) can be viewed as equivalent to locating a graph G_{S} as a subgraph of G_{Q} (e.g., G_{QS}) such that the weighted sum of the edge weights of G_{QS} is minimized. Accordingly, graph analysis component 314 can determine an index assignment mapping in accordance with one aspect by applying a variation of the subgraph isomorphism problem.

It should be appreciated that the only constraint imposed on the signaling scheme as described herein is that the signaling scheme must be discrete. Accordingly, the graph-theoretic formulation that can be applied by index assignment component 310 can include both binary and non-binary index assignment as well as both coded and uncoded transmission. In one example, if the signaling scheme is a channel code, then solving the index assignment problem can be viewed as solving a generic joint source-channel coding problem.

In accordance with one aspect, graph analysis component 314 and/or another suitable component within system 300 can formulate the subgraph isomorphism problem as follows. First, a subgraph isomorphism of a graph G₁=(V₁,E₁) into a graph G₂=(V₂, E₂) can be defined as an injection Ω⊂V₁×V₂ such that, for every pair of vertices vᵢ, vⱼεV₁ and wᵢ, wⱼεV₂ with (vᵢ,wᵢ)εΩ and (vⱼ,wⱼ)εΩ, (wᵢ, wⱼ)εE₂ if (vᵢ,vⱼ)εE₁. In such a case, Ω can be regarded as a subgraph isomorphism of G₁ into G₂. Based on this definition, the subgraph isomorphism problem often raises two issues. First, given graphs G₁ and G₂, it generally must be determined whether subgraph isomorphism exists. Second, if subgraph isomorphism does exist, subgraph isomorphisms of G₁ into G₂ can be found.

In accordance with one aspect, graph analysis component 314 can conduct the subgraph isomorphism problem by determining subgraph isomorphisms of G_{S} into G_{Q}. Since, as described above, G_{Q} is a complete graph, it can be assumed that any G_{S} can be found in G_{Q} provided that |G_{S}|≦M. As a result, graph analysis 314 can assume that subgraph isomorphism from G_{S} into G_{Q} exists and therefore require only to find the subgraph isomorphisms of G_{S} into G_{Q}. In one example, an index assignment mapping can be determined by identifying all subgraph isomorphisms of G_{S} into G_{Q} and computing an average distortion of each identified subgraph isomorphism. The subgraph isomorphism having a minimum average distortion can then be regarded as the optimal solution to the index assignment problem.

As one of ordinary skill in the art can appreciate, subgraph isomorphism detection is an NP-complete problem. Therefore, the time required for detection of a subgraph isomorphism between two graphs is in the worst case exponential in the number of vertices of the graphs. Many algorithms have been proposed for solving the subgraph isomorphism problem, but many of them in the worst case become computationally intractable. Additionally, continuous optimizations methods have been proposed with the goal of obtaining a solution within a reasonable time that may not necessarily be the optimal solution. In one example, system 300 can improve upon these conventional techniques by simplifying the signal adjacency graph prior to solving the subgraph isomorphism problem in accordance with the following description.

In accordance with one aspect, many situations, such as the presence of additive white Gaussian noise (AWGN) in a communication channel, can facilitate the interpretation of the pairwise conditional error probability P(ŝ=\vec{s}ⱼ|s=\vec{s}ᵢ) as P(\vec{r}εVⱼ|s=\vec{s}ᵢ), where \vec{r} is a received signal and Vⱼ is the decision region of signal \vec{s}ⱼ. In one example, the probability P(\vec{r}εVⱼ|s=\vec{s}ᵢ) can depend on the Euclidean distance between \vec{s}ᵢ and \vec{r}. Moreover, P(\vec{r}εVⱼ|s=\vec{s}ᵢ) can be expressed as a Q-function of the Euclidean distance; e.g., P(\vec{r}εVⱼ|s=\vec{s}ᵢ) decreases exponentially as the distance between \vec{s}ᵢ and \vec{r} increases. Further, as SNR increases, the distance between \vec{s}ᵢ and \vec{r} can increase, thereby causing P(\vec{r}εVⱼ|s=\vec{s}ᵢ) to decrease.

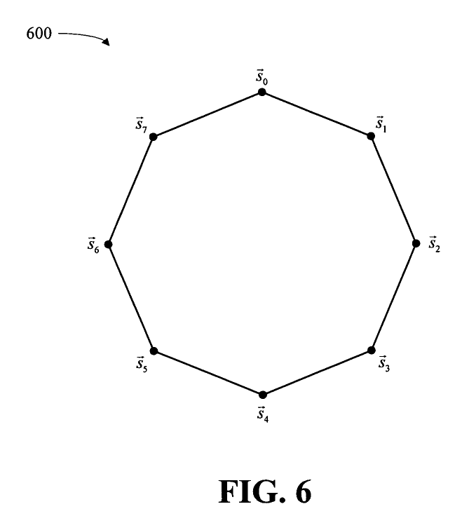

As P(\vec{r}εVⱼ|s=\vec{s}ᵢ) decreases, the set of dominating error events of \vec{s}ᵢ, E_{dom,i}, reduces. Thus, at a certain SNR, the set E_{dom,i} can contain only elements which are the Voronoi neighbor(s) of \vec{s}ᵢ in the decision space. In other words, if SNR is sufficiently high, then the error events of the Voronoi neighbors of a signal will dominate all of the error events. Therefore, distortion contributed by the error events of the Voronoi neighbors will dominate D_{C}(Q_{Π}_{ₛ}). Using the example illustrated by graph 520 in FIG. 5B and assuming a sufficiently high SNR, graph 520 can then be further simplified by deleting all edges connected to non-Voronoi neighbors of each signal. The graph resulting from these simplifications is illustrated by graph 600 in FIG. 6.

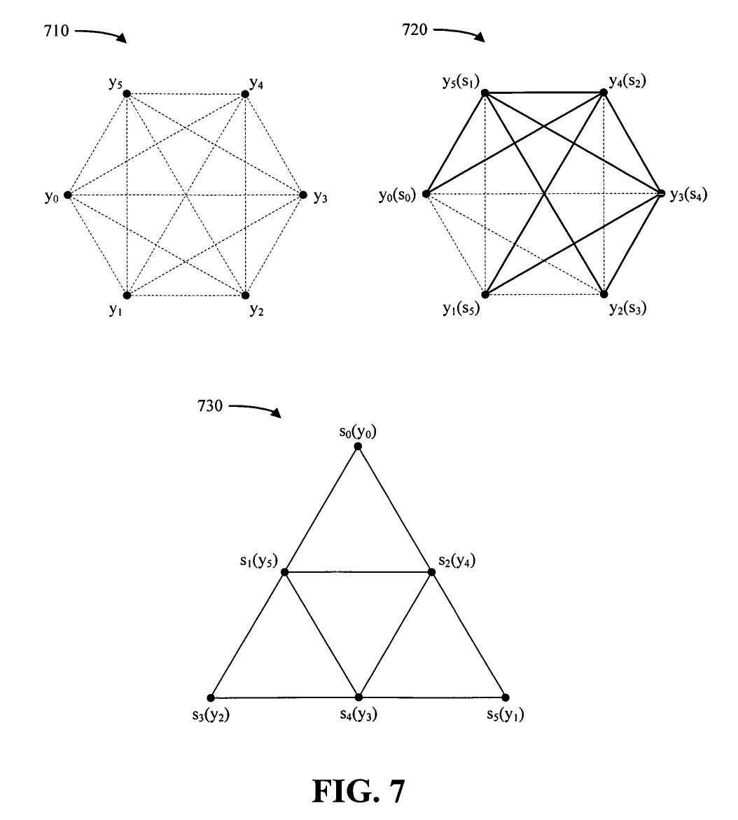

By way of specific example, index assignment component 310 can utilize these simplifications to determine an index assignment mapping for a set of codevectors and a signal constellation as shown in FIG. 7. In the example illustrated by FIG. 7, a quantizer with six codevectors with quantizer graph G_{Q} shown in graph 710 and a signal constellation with signal adjacency graph G_{S} as shown in graph 730 is utilized. As illustrated by graph 720, an index assignment mapping determined by index assignment component 310 can be a mapping from G_{S} to G_{QS}⊂G_{Q} such that the topology of G_{S} is preserved.

In another specific example, a signal constellation S can be a linear block code. Various techniques are known in the art to identify all Voronoi neighbors of a codeword of a binary linear block code. Based on the result of these techniques, a signal adjacency graph G_{S} for a binary linear block code can be defined. By applying this signal adjacency graph to the algorithms described above, the index assignment problem can be solved as a joint source-channel coding problem.

In accordance with one aspect, special cases of the subgraph isomorphism problem solved by index assignment component 310 exist in various examples where G_{S} has a special topology. The following description presents some of these examples.

In one example, a special case of the subgraph isomorphism problem exists when G_{S} is a complete graph. This case can lead to two extremes. The first such extreme occurs when the probabilities P(ŝ=\vec{s}ⱼ|s=\vec{s}ᵢ) for all j≠i and for all i are all significant but not equal. It can be observed that this extreme is the worst case scenario, as finding an optimal solution can require an exhaustive search of all M! possible mappings. The other extreme occurs when all such probabilities are equal. It can be observed that finding an optimal solution for this extreme is trivial as all index assignment mappings are equivalent. In the case of a Gaussian channel, this trivial case is associated to a situation wherein all signals are equidistant in the signal space.

Two examples of the trivial case are now presented. The first such example is an orthogonal signal set where G_{S} is a regular simplex. If M=3 and 4, G_{S} can be represented as an equilateral triangle and equilateral tetrahedron, respectively. In general, G_{S} can be represented by a complete graph in such an example where all edges have the same weight. The second such example is an equidistant code. More particularly, a code can be referred to as equidistant if all distances between distinct codewords are equal. Accordingly, a signal adjacency graph G_{S} of an equidistant code can be represented as a complete graph where all edges have the same weight. Examples of equidistant codes include dual codes to the binary Hamming codes, which can also be referred to as “simplex codes.”

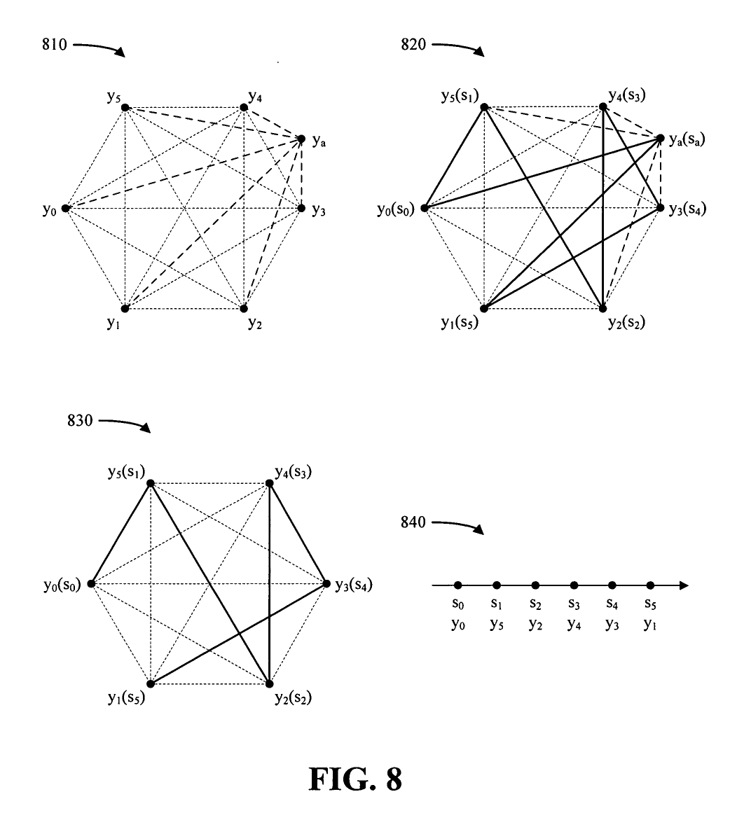

In another such example, a special case of the subgraph isomorphism problem exists when G_{S} is a graph of line topology. In one example, if G_{S} has a line topology, then the index assignment problem can be solved by finding a Hamiltonian path with minimum cost through G_{Q}. This case can arise, for example, when a utilized signal set S is a Pulse Amplitude Modulation (PAM) constellation. In accordance with one aspect, this case can be solved as a variation of the Traveling Salesman Problem (TSP) as illustrated by FIG. 8.

In the example illustrated by FIG. 8, the index assignment problem is conducted for a 6-PAM constellation, which is illustrated by graph 840. To solve the index assignment problem for such a case, an auxiliary node and auxiliary edges can be added to the complete graph G_{Q} to form an augmented graph G̅_̅{̅Q̅}̅ as shown in graph 810. From graph 810, it can be observed that G̅_̅{̅Q̅}̅ is a complete graph with M+1 nodes. Further, the edge weight of each of the auxiliary edges can be set to 0. Thus, in solving the TSP over G̅_̅{̅Q̅}̅, the optimal solution must pass through the auxiliary node, and the edges connected to that node must have weights 0. The solution to the TSP over G̅_̅{̅Q̅}̅ is illustrated by graph 820. By removing the auxiliary node and corresponding edges, a Hamiltonian path with minimum cost is obtained as illustrated by graph 830.

In accordance with one aspect, system 300 can facilitate the determination of an index assignment mapping that minimizes an overall bit error rate (BER) for binary data transmitted using a high-order modulation scheme such as PSK or quadrature amplitude modulation (QAM). In the case of a binary data source wherein Hamming distortion is utilized as a distortion measure, the index assignment problem can be solved by finding a mapping from binary data sources to corresponding signals in a signal constellation such that the overall BER (e.g., the overall Hamming distortion) is minimized. Thus, the subgraph isomorphism problem can be utilized by system 300 in such a case.

In accordance with one aspect, the subgraph isomorphism problem can be used to minimize the overall BER in such a case as follows. First, the size M and the topology of the signal constellation (e.g., G_{S}) can be determined. Next, every possible combination of log₂ M bits can be grouped as respective binary vectors. By doing so, M binary vectors can be created that constitute V_{Q} of G_{Q}, which is a complete graph of order M. Labels of edges connecting respective nodes i and j can then be set to the Hamming distances between the corresponding binary vectors. Based on this formation of G_{Q}, finding a mapping that minimizes the BER can be accomplished by finding G_{S} from G_{Q} such that the overall Hamming distortion is minimized.

By way of specific example, Gray-coded M-PSK can be viewed as the solution of the TSP over a binary hypercube of dimension log₂ M. In another such example, Gray-coded M²-QAM can be viewed in a similar manner to 4096-QAM, which takes advantage of the independence between in-phase and quadrature-phase components such that each dimension is considered as M-PAM. As a result, finding an index assignment mapping that minimizes BER for M²-QAM can be accomplished by solving the index assignment problem from a binary hypercube to a line topology, e.g., by finding a minimum cost Hamiltonian path inside a binary hypercube.

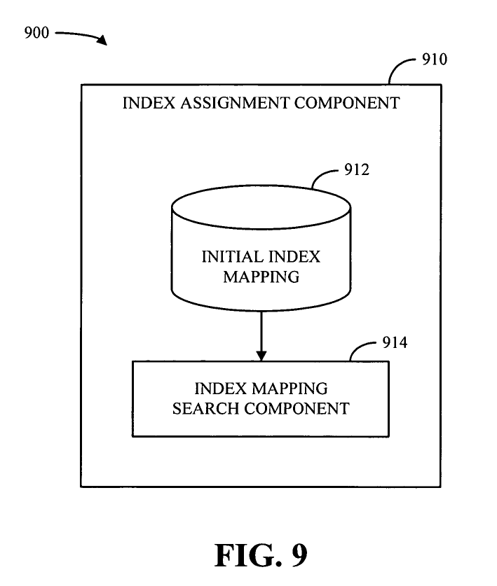

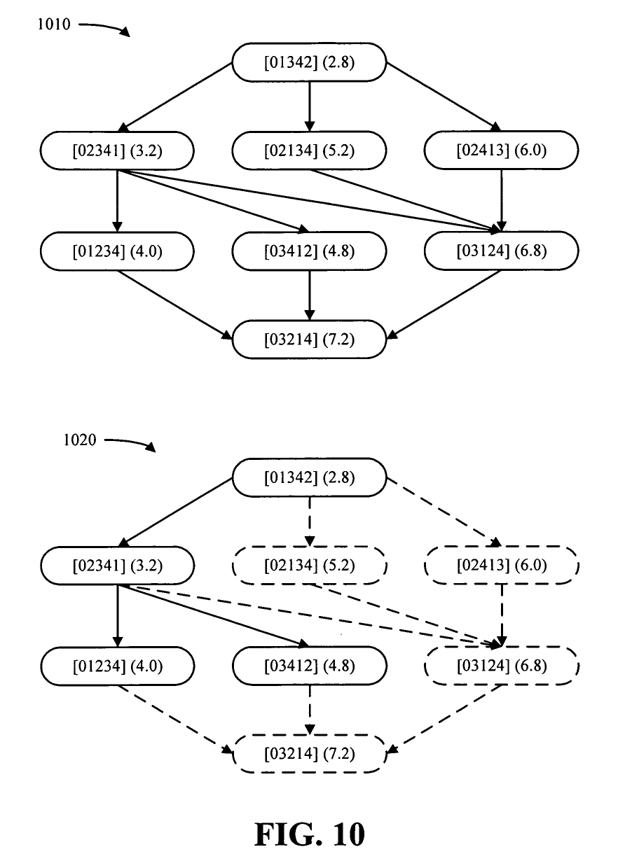

Turning now to FIG. 9, a system 900 for optimizing an index mapping in accordance with various aspects is illustrated. As FIG. 10 illustrates, system 900 can include an index assignment component 910, which can determine or otherwise obtain an initial index mapping 912. Based on the initial index mapping 912, an index mapping search component 914 can obtain an optimal or near-optimal index mapping for a communication channel in which system 900 operates.

In accordance with one aspect, system 900 can operate as follows. As described supra with regard to FIGS. 3 and 6, an optimal index mapping can be determined in certain cases by ignoring all but the Voronoi neighbors of each signal in an associated signal set. As further described with regard to FIGS. 3 and 6, however, this procedure assumes that the SNR of an associated communication channel is moderate to high. Further, the described procedure assumes that the quantized output of the communication system is uniformly distributed. Such assumptions imply that the source statistics are known and that a matched compandor is used. Further, such assumptions imply that error events within the same neighborhood levels are equiprobable. In practice, however, it can be difficult to design a compandor that matches source statistics perfectly. As a result, the probability distributions of the compandor output and the corresponding quantized output are often not uniform.

In such cases, while nearest neighbor error events remain the most significant error events, such events are no longer the only dominant factor in the overall source distortion. Thus, to find a globally optimal mapping, index assignment component 910 can investigate mappings with small amounts distortion from an initial index mapping 912. In one example, the index mapping search component 914 can make use of the idea of arc inversion. More particularly, given an initial index mapping 912 that is optimal based on an assumption of a moderate to high SNR and uniformly distributed quantized output, the index mapping search component 914 can search for other mappings with small overall source distortion by performing successive arc inversions on the initial index mapping 912. By doing so, index assignment component 910 can quickly determine candidate index mappings for an associated communication system without requiring an exhaustive search. From these candidate index mappings, an index mapping that is optimal for the communication system can be selected based on channel characteristics of the system, the quantizer output distribution of the system, and/or other factors.

Thus, by way of specific, non-limiting example, the index mapping search component 914 can operate according to the following algorithm for searching optimal mapping(s) based on an initial index mapping 912 that is optimal for a moderate to high SNR and a uniformly distributed quantized output. Using nearest neighbor mean p-th power distortion (NNMPD) as a distortion measure, Ξ(δ)={ξ:ε₁(ξ)≦ε₁(ξ_{z})+δ} can be defined as the set of mappings having NNMPDs smaller than a given value. In one example, the cardinality of this set can be controlled by a threshold value δ above the NNMPD of the initial index mapping 912 (denoted herein as ξ_{z}). Thus, the size of the set increases as δ increases. In particular, when δ is infinity, Ξ(∞) can be equivalent to the whole search space, and when δ is zero, Ξ(0) can contain only the initial index mapping 912. Further, as used herein, a mapping ξᵢ is referred to as a predecessor of another mapping ξⱼ if ξⱼ can be obtained by performing an arc inversion on ξᵢ and ε₁(ξⱼ)≧ε₁(ξᵢ). Further, if a mapping is denoted as a vertex in a graph, and the predecessor relationship is denoted as an arrow (e.g., a directed edge), then Ξ(δ) can be represented as a directed graph. FIG. 10 illustrates two examples of directed graphs that can represent Ξ(δ) for an example communication system. In particular, graph 1010 in FIG. 10 represents a case where δ is infinity and p=2, and graph 1020 represents a case where δ=2 with p=2.

In accordance with one aspect, system 900 can perform an algorithm based on a branch-and-bound tree search, such as the breadth-first search (BFS), for searching index mappings as follows. First, a value for δ is fixed and Ξ(δ) is initialized to contain only the initial index mapping ξ_{z}. An intermediate variable ζ is then set equal to ξ_{z} and given an indicator of ‘0.’ In one example, an indicator of ‘0’ can indicate that a mapping is to be processed, while an indicator of ‘1’ can indicate that a mapping has already been processed. Next, all possible arc inversions are performed on ζ, and the indicator of ζ is set to ‘1.’ The index mappings obtained by performing arc inversions on ζ can then be examined, and any such mappings having an NNMPD over ε₁(ξ_{z})+δ or under that of ζ or having an indicator of ‘1’ can be disregarded. All other index mappings can then be added to Ξ(δ) and given respective indicator values of ‘0.’ After all eligible index mappings have been added to Ξ(δ), a new index mapping ξεΞ(δ) having an indicator of ‘0’ can be selected, and the intermediate variable ζ can be set to ξ. The above process is then repeated for the new ζ and all elements of Ξ(δ) until the indicator for each element of Ξ(δ) is ‘1.’ Once the indicator for each element of Ξ(δ) is ‘1,’ the whole set of Ξ(δ) has been obtained.

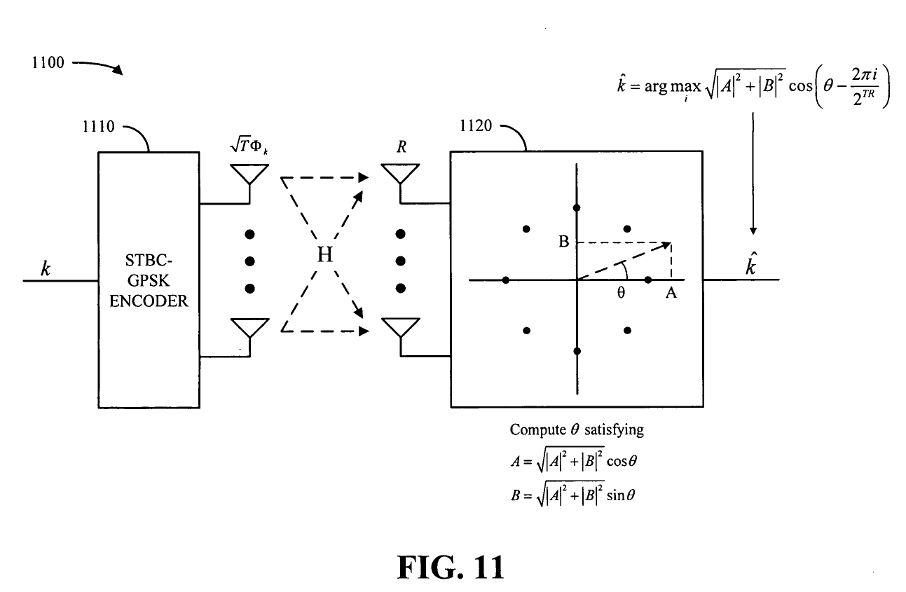

Referring to FIG. 11, a system 1100 that facilitates index assignment mapping for a multiple-input multiple-output (MIMO) communication system is illustrated. System 1100 includes a Space-Time Block Code (STBC)-Generalized PSK (GPSK) encoder 1110, which can communicate data and/or other information to a receiver 1120. In accordance with one aspect, encoder 1110 and receiver 1120 can communicate using a construction of simply encodable and decodable non-coherent unitary space-time codes. In one example, codewords used by system 1100 are designed in such a way that a received signal at receiver 1120 is used to compute a phase angle. The received signal can then be decoded by receiver 1120 as a codeword having a corresponding phase angle that is the nearest to the phase angle of the received signal. This class of codes is often referred to as Generalized PSK due to the fact that this decoding procedure is similar to the detection process of PSK and that the geometry of the decoding space of this space-time code can be associated with the geometry of the PSK signal constellation.

In accordance with one aspect, various techniques described herein can be used by system 1100 to generate an index assignment mapping from scalar quantizers to GPSK codewords, which can have a ring topology in decoding space. To facilitate a thorough understanding of how this can be achieved, the following describes various aspects of encoding and decoding for a GPSK system.

Referring again to FIG. 11, a system model of a GPSK system 1100 is illustrated. Nₜ and Nᵣ can be respectively defined as the number of transmit and receive antennas in system 1100. Further, H can be defined as an Nₜ×Nᵣ matrix wherein the (i,j)-th entry is the channel gain from transmit antenna i to receive antenna j. The (i,j)-th entry of H can further be modeled as an independent complex Gaussian random variable

$$𝒞𝒩 ( 0 , \frac{1}{Nt} )$$

and denotes as α_{i,j}. In addition, Φ can be defined as a transmitted codeword matrix selected from a T×Nₜ matrix constellation C={\sqrt{T}Φₖ|k=0, 1, . . . , L−1}, where L is the number of codewords. In one example, the (t,i)-th entry in Φ, denoted as c_{t,i}, is transmitted by antenna i at time t. In another example, the communication channel used by system 1100 is quasi-static over a length of T. Thus, a received codeword can be expressed as follows:

R=ΦH+N, (15)

where N is a T×Nᵣ matrix whose (t, j)-th entry represents additive noise that is modeled as

$$𝒞𝒩 ( 0 , \frac{1}{ρ} ) ,$$

and ρ is the expected SNR at each receive antenna. Further, R=(log₂ L)/T can be defined as the rate of the code.

In one example, T=2Nₜ and each Φ has a special form. Based on this, k can be defined as an input information symbol. A codeword matrix corresponding to this symbol, denoted as \sqrt{T}Φₖ, can then be transmitted through the channel. Next, let Φₖ=[φ_{1,k},φ_{2,k}, . . . , φ_{N}_{ₜ}_{,k}], where 0≦k≦2^{TR}−1 and φ_{j,k} is the j-th column vector of Φₖ. Based on this definition, φ_{j,k} can be expressed as follows:

φ_{j,k}=cos(πk/2^{TR})eⱼ+sin(πk/2^{TR})e_{j+N}_{ₜ}, (16)

where eⱼ is a T-dimensional column vector configured such that its j-th component is equal to 1 and all other components are equal to 0.

Based on these definitions, maximum likelihood (ML) decoding can be conducted as follows. First, a received codeword at receiver 1120 can be expressed as R=[R₁, R₂, . . . , R_{N}_{ᵣ}] The following definitions can then be made:

$$A = {\sum }_{j = 1}^{{N}_{r}} {\sum }_{l = 1}^{{N}_{i}} \frac{{\vert {ℛ}_{j} \cdot {e}_{l} \vert}^{2} - {\vert {ℛ}_{j} \cdot {e}_{l + {N}_{t}} \vert}^{2}}{2} \\ B = ℜ ( {\sum }_{j = 1}^{{N}_{r}} {\sum }_{l = 1}^{{N}_{i}} ( {ℛ}_{j} \cdot {e}_{l} ) {( {ℛ}_{j} \cdot {e}_{l + {N}_{t}} )}^{H} ) , \qquad ( 17 )$$

where [symbol] (•) is the real part operator and A^{H} denotes the Hermitian of A. Next, a phase angle 0≦θ<2π can be computed that satisfies the conditions

$$A = \sqrt{{\vert A \vert}^{2} + {\vert B \vert}^{2}}$$

cos θ and

$$B = \sqrt{{\vert A \vert}^{2} + {\vert B \vert}^{2}}$$

sin θ. Based on this, maximum likelihood decoding then becomes a determination of a value of \hat{k} that maximizes the following:

$$\sqrt{{\vert A \vert}^{2} + {\vert B \vert}^{2}} cos ( θ - \frac{2 π k}{{2}^{TR}} ) . \qquad ( 18 )$$

From the above discussion, it can be observed that each codeword matrix corresponds to a unique phase angle θ. Thus, θⱼ can be defined as a phase angle corresponding to Φⱼ. From this, it can be shown that |θⱼ₊₁−θⱼ|=|θᵢ₊₁−θₗ| for any j, l mod L. Based on the above-described detection scheme, it can be appreciated that the detection space of this class of space-time code is the same as that of PSK. Based on this property, quantized data can be mapped to respective codeword matrices in system 1100 in accordance with the various aspects described supra. In one example, the symbol rate of system 1100 can be improved by adjusting the number of transmit and/or receive antennas used by system 1100. Thus, a reasonable symbol error rate can be achieved even for a significantly large constellation size by employing additional antennas. Therefore, the index assignment techniques described herein can be applied to large GPSK constellations.

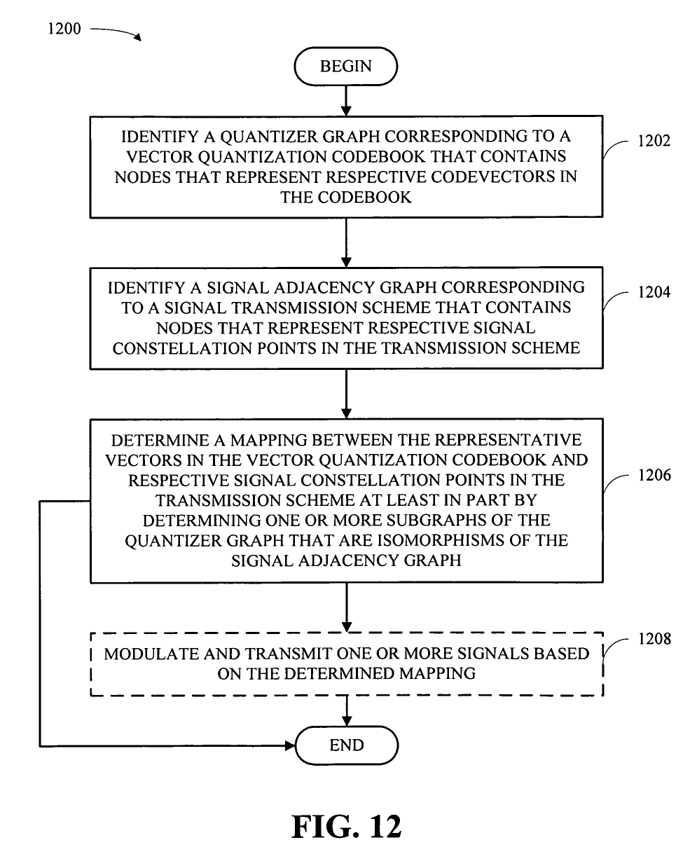

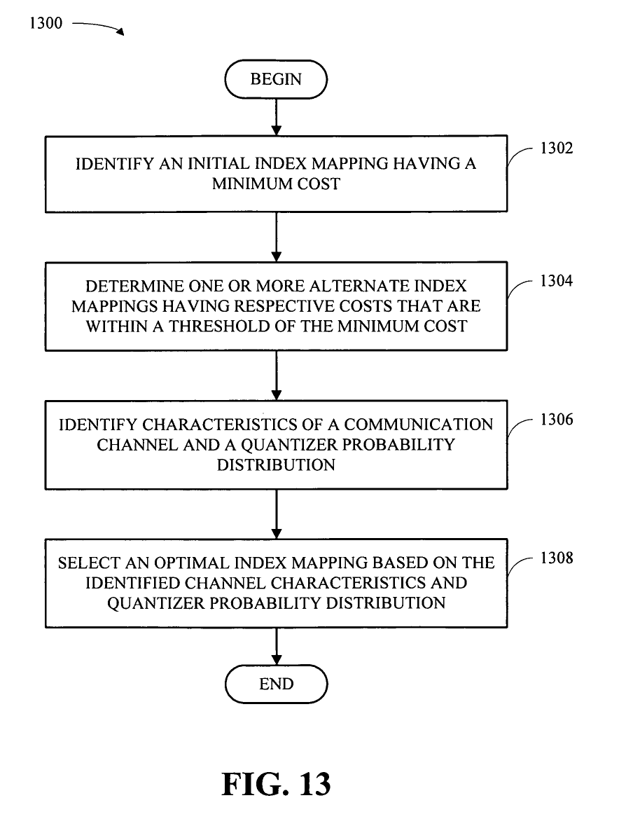

Referring now to FIGS. 12-13, methodologies that can be implemented in accordance with various aspects described herein are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies in accordance with the claimed subject matter.

Furthermore, the claimed subject matter may be described in the general context of computer-executable instructions, such as program modules, executed by one or more components. Generally, program modules include routines, programs, objects, data structures, etc., that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Referring to FIG. 12, a method 1200 of assigning indices for respective quantization levels used for wireless communication is illustrated. At 1202, a quantizer graph is identified (e.g., by a graphing component 312 associated with an index assignment component 310) that corresponds to a vector quantization codebook. In one example, the quantizer graph can contain nodes that represent respective codevectors in the codebook. At 1204, a signal adjacency graph is identified that corresponds to a signal transmission scheme. In one example, the signal adjacency graph can contain nodes that represent respective signal constellation points in the transmission scheme. Next, at 1206, a mapping between the representative vectors in the vector quantization codebook and respective signal constellation points in the transmission scheme is determined (e.g., by a graph analysis component 314) at least in part by determining one or more subgraphs of the quantizer graph that are isomorphisms of the signal adjacency graph. Method 1200 can then conclude or alternatively proceed to 1208 prior to concluding, wherein one or more signals and modulated and transmitted based on the mapping determined at 1206.

Turning now to FIG. 13, a flowchart of a method 1300 of optimizing an index mapping for quantization is provided. At 1302, an initial index mapping having a minimum cost (e.g., initial index mapping 912) is identified. At 1304, one or more alternative index mappings having respective costs that are within a threshold of the minimum cost identified at 1302 are determined (e.g., by an index mapping search component 914). At 1306, characteristics of a communication channel and a quantizer probability distribution are identified. At 1308, an optimal index mapping is selected from the index mappings identified at 1302 and/or 1304 based on the channel characteristics and quantizer probability distribution identified at 1306.

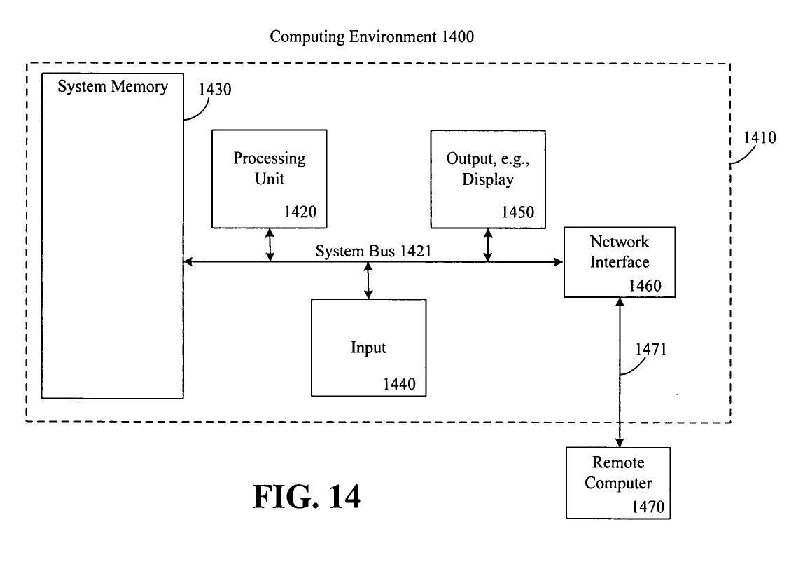

Turning to FIG. 14, an exemplary non-limiting computing system or operating environment in which various aspects described herein may be implemented is illustrated. One of ordinary skill in the art can appreciate that handheld, portable and other computing devices and computing objects of all kinds are contemplated for use in connection with the claimed subject matter, i.e., anywhere that a communications system may be desirably configured. Accordingly, the below general purpose remote computer described below in FIG. 14 is but one example of a computing system in which the claimed subject matter can be implemented.

Although not required, the claimed subject matter can partly be implemented via an operating system, for use by a developer of services for a device or object, and/or included within application software that operates in connection with one or more components of the claimed subject matter. Software may be described in the general context of computer-executable instructions, such as program modules, being executed by one or more computers, such as client workstations, servers or other devices. Those skilled in the art will appreciate that the claimed subject matter can also be practiced with other computer system configurations and protocols.

FIG. 14 thus illustrates an example of a suitable computing system environment 1400 in which the claimed subject matter may be implemented, although as made clear above, the computing system environment 1400 is only one example of a suitable computing environment for a media device and is not intended to suggest any limitation as to the scope of use or functionality of the claimed subject matter. Further, the computing environment 1400 is not intended to suggest any dependency or requirement relating to the claimed subject matter and any one or combination of components illustrated in the example operating environment 1400.

With reference to FIG. 14, an example of a remote device for implementing various aspects described herein includes a general purpose computing device in the form of a computer 1410. Components of computer 1410 can include, but are not limited to, a processing unit 1420, a system memory 1430, and a system bus 1421 that couples various system components including the system memory to the processing unit 1420. The system bus 1421 can be any of several types of bus structures including a memory bus or memory controller, a peripheral bus, and a local bus using any of a variety of bus architectures.

Computer 1410 can include a variety of computer readable media. Computer readable media can be any available media that can be accessed by computer 1410. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1410. Communication media can embody computer readable instructions, data structures, program modules or other data in a modulated data signal such as a carrier wave or other transport mechanism and can include any suitable information delivery media.

The system memory 1430 can include computer storage media in the form of volatile and/or nonvolatile memory such as read only memory (ROM) and/or random access memory (RAM). A basic input/output system (BIOS), containing the basic routines that help to transfer information between elements within computer 1410, such as during start-up, can be stored in memory 1430. Memory 1430 can also contain data and/or program modules that are immediately accessible to and/or presently being operated on by processing unit 1420. By way of non-limiting example, memory 1430 can also include an operating system, application programs, other program modules, and program data.

The computer 1410 can also include other removable/non-removable, volatile/nonvolatile computer storage media. For example, computer 1410 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 1421 through a non-removable memory interface such as an interface, and a magnetic disk drive or optical disk drive can be connected to the system bus 1421 by a removable memory interface, such as an interface.

A user can enter commands and information into the computer 1410 through input devices such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 1420 through user input 1440 and associated interface(s) that are coupled to the system bus 1421, but can be connected by other interface and bus structures, such as a parallel port, game port or a universal serial bus (USB). A graphics subsystem can also be connected to the system bus 1421. In addition, a monitor or other type of display device can be connected to the system bus 1421 via an interface, such as output interface 1450, which can in turn communicate with video memory. In addition to a monitor, computers can also include other peripheral output devices, such as speakers and/or a printer, which can also be connected through output interface 1450.

The computer 1410 can operate in a networked or distributed environment using logical connections to one or more other remote computers, such as remote computer 1470, which can in turn have media capabilities different from device 1410. The remote computer 1470 can be a personal computer, a server, a router, a network PC, a peer device or other common network node, and/or any other remote media consumption or transmission device, and can include any or all of the elements described above relative to the computer 1410. The logical connections depicted in FIG. 14 include a network 1471, such local area network (LAN) or a wide area network (WAN), but can also include other networks/buses. Such networking environments are commonplace in homes, offices, enterprise-wide computer networks, intranets and the Internet.

When used in a LAN networking environment, the computer 1410 is connected to the LAN 1471 through a network interface or adapter. When used in a WAN networking environment, the computer 1410 can include a communications component, such as a modem, or other means for establishing communications over the WAN, such as the Internet. A communications component, such as a modem, which can be internal or external, can be connected to the system bus 1421 via the user input interface at input 1440 and/or other appropriate mechanism. In a networked environment, program modules depicted relative to the computer 1410, or portions thereof, can be stored in a remote memory storage device. It should be appreciated that the network connections shown and described are exemplary and other means of establishing a communications link between the computers can be used.

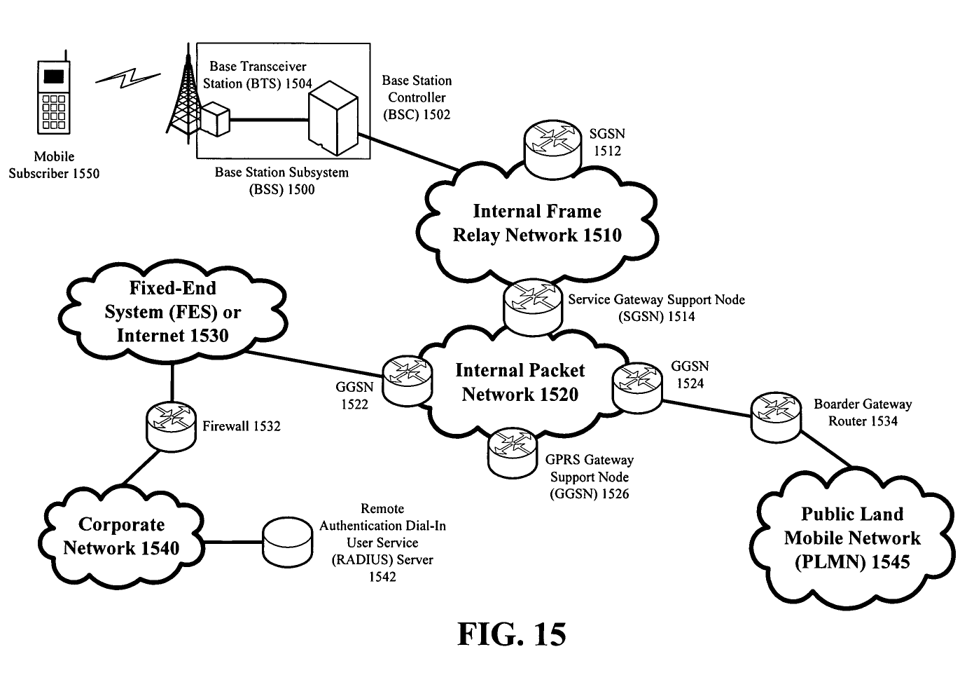

Turning now to FIG. 15, an overview of a network environment in which the claimed subject matter can be implemented is illustrated. The above-described systems and methodologies for timing synchronization may be applied to any wireless communication network; however, the following description sets forth an exemplary, non-limiting operating environment for said systems and methodologies. The below-described operating environment should be considered non-exhaustive, and thus the below-described network architecture is merely an example of a network architecture into which the claimed subject matter can be incorporated. It is to be appreciated that the claimed subject matter can be incorporated into any now existing or future alternative architectures for communication networks as well.

FIG. 15 illustrates various aspects of the global system for mobile communication (GSM). GSM is one of the most widely utilized wireless access systems in today's fast growing communications systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the timing synchronization techniques described herein may be applied independently of the method of data transport, and does not depend on any particular network architecture or underlying protocols.

FIG. 15 depicts an overall block diagram of an exemplary packet-based mobile cellular network environment, such as a GPRS network, in which the claimed subject matter can be practiced. Such an environment can include a plurality of Base Station Subsystems (BSS) 1500 (only one is shown), each of which can comprise a Base Station Controller (BSC) 1502 serving one or more Base Transceiver Stations (BTS) such as BTS 1504. BTS 1504 can serve as an access point where mobile subscriber devices 1550 become connected to the wireless network. In establishing a connection between a mobile subscriber device 1550 and a BTS 1504, one or more timing synchronization techniques as described supra can be utilized.

In one example, packet traffic originating from mobile subscriber 1550 is transported over the air interface to a BTS 1504, and from the BTS 1504 to the BSC 1502. Base station subsystems, such as BSS 1500, are a part of internal frame relay network 1510 that can include Service GPRS Support Nodes (“SGSN”) such as SGSN 1512 and 1514. Each SGSN is in turn connected to an internal packet network 1520 through which a SGSN 1512, 1514, etc., can route data packets to and from a plurality of gateway GPRS support nodes (GGSN) 1522, 1524, 1526, etc. As illustrated, SGSN 1514 and GGSNs 1522, 1524, and 1526 are part of internal packet network 1520. Gateway GPRS serving nodes 1522, 1524 and 1526 can provide an interface to external Internet Protocol (“IP”) networks such as Public Land Mobile Network (“PLMN”) 1545, corporate intranets 1540, or Fixed-End System (“FES”) or the public Internet 1530. As illustrated, subscriber corporate network 1540 can be connected to GGSN 1522 via firewall 1532; and PLMN 1545 can be connected to GGSN 1524 via boarder gateway router 1534. The Remote Authentication Dial-In User Service (“RADIUS”) server 1542 may also be used for caller authentication when a user of a mobile subscriber device 1550 calls corporate network 1540.

Generally, there can be four different cell sizes in a GSM network—macro, micro, pico, and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The claimed subject matter has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

What is claimed is:

1. A computer-readable storage medium comprising computer-executable components of a system for providing index mapping for quantization, the system comprising:
a graphing component that processes a quantization codebook and a signal constellation to generate respective graphical representations thereof; and
a graph analysis component that identifies an index mapping from the quantization codebook to the signal constellation at least in part by identifying a subgraph of a graphical representation of the quantization codebook that is an isomorphism of the graphical representation of the signal constellation.

2. The system of claim 1, wherein the graph analysis component identifies an index mapping from the quantization codebook to the signal constellation that minimizes a total combined mean p-th power distortion between respective elements of the quantization codebook.

3. The system of claim 1, wherein the graphical representation of the quantization codebook generated by the graphing component is a complete graph that comprises one or more nodes corresponding to respective elements of the quantization codebook and one or more edges that connect the one or more nodes, respective edges are weighted by respective amounts of distortion between nodes connected by the respective edges.

4. The system of claim 1, wherein the graphical representation of the signal constellation generated by the graphing component comprises one or more nodes corresponding to respective signals in the signal constellation and one or more edges that connect respective nodes for which dominating transmission error events exist.

5. The system of claim 4, wherein the graphical representation of the signal constellation generated by the graphing component is a graph of line topology and the graph analysis component identifies an index mapping from the quantization codebook to the signal constellation at least in part by identifying a Hamiltonian path through the graphical representation of the quantization codebook that minimizes a total combined distortion between respective elements of the quantization codebook.

6. The system of claim 1, further comprising an index mapping search component that receives the index mapping from the quantization codebook to the signal constellation identified by the graph analysis component and identifies one or more additional candidate index mappings at least in part by performing respective arc inversion operations on the index mapping identified by the graph analysis component.

7. The system of claim 6, wherein the index mapping search component selects at least one of the index mapping identified by the graph analysis component or the one or more candidate index mappings to minimize an overall amount of distortion between respective elements of the quantization codebook

8. A wireless multiple-input multiple-output (MIMO) communication system comprising the system of claim 1, wherein the signal constellation comprises space-time block codes.

9. A wireline communication system comprising the system of claim 1.

10. A data storage system comprising the system of claim 1.

11. The system of claim 1, wherein the signal constellation is non-binary.

12. A method of determining an index assignment mapping for quantization in a wireless communication system, comprising:
identifying a quantizer graph corresponding to a quantization codebook and a signal adjacency graph corresponding to a signal transmission scheme; and
determining an index assignment mapping between the quantization codebook and the signal transmission scheme at least in part by determining one or more subgraphs of the quantizer graph that are isomorphisms of the signal adjacency graph.

13. The method of claim 12, wherein the determining an index assignment mapping comprises selecting a subgraph of the quantizer graph from the one or more subgraphs of the quantizer graph that are isomorphisms of the signal adjacency graph that minimizes overall combined distortion.

14. The method of claim 12, wherein the signal adjacency graph has a line topology and the determining an index assignment mapping comprises determining a Hamiltonian path through the quantizer graph that minimizes overall combined distortion.

15. The method of claim 14, wherein the determining a Hamiltonian path through the quantizer graph comprises:
adding an auxiliary node and auxiliary edges to the quantizer graph to create an augmented graph; and
determining a Hamiltonian cycle through the augmented graph that minimizes overall combined distortion.

16. The method of claim 12, further comprising:
performing respective arc inversions on the determined index assignment mapping to obtain one or more additional index assignment mappings; and
selecting an index assignment mapping that minimizes distortion based on one or more of a channel quality associated with the wireless communication system or a quantizer output distribution for the wireless communication system.

17. The method of claim 12, wherein the signal transmission scheme comprises a non-binary modulator constellation.

18. The method of claim 12, wherein the wireless communication system is a MIMO system and the signal transmission scheme comprises a set of space-time block codes.

19. A computer-readable medium having stored thereon instructions operable to perform the method of claim 12.

20. A system that facilitates low-distortion symbol mapping for a wireless communication system, comprising:
means for identifying a vector quantization scheme and a signal constellation utilized by the wireless communication system;
means for graphically representing the vector quantization scheme and the signal constellation by generating respective graphs therefor; and
means for determining an index assignment mapping from the vector quantization scheme to the signal constellation at least in part by identifying one or more subgraphs of the graph generated for the vector quantization scheme that are isomorphisms of the graph generated for the signal constellation.
